(19) United States
(12) Patent Application Publication
(10) Pub. No.: US 2014/0206248 A1
(43) Pub. Date: Jul. 24, 2014

(54) IMPACT DISSIPATING FABRIC

(71) Applicant: MATSCITECHNO LICENSING COMPANY, Kennett Square, PA (US)

(72) Inventor: Robert A. Vito, Kennett Square, PA (US)

(73) Assignee: MATSCITECHNO LICENSING COMPANY, Kennett Square, PA (US)

(21) Appl. No.: 13/975,447

(22) Filed: Aug. 26, 2013

Related U.S. Application Data
(63) Continuation-in-part of application No. 13/331,004, filed on Dec. 20, 2011, now abandoned.
(60) Provisional application No. 61/714,279, filed on Oct. 16, 2012.

(51) Int. Cl. F41H 1/02; B32B 5/26; D03D 9/00; D04H 1/4291; D03D 1/00; D03D 13/00; B32B 5/02; D04H 1/4342

(52) U.S. Cl. CPC F41H 1/02; B32B 5/022; B32B 5/024; B32B 5/26; D04H 1/4342; D04H 1/4291; D03D 1/0052; D03D 13/00; D03D 9/00
USPC 442/2; 442/381; 442/392; 442/268; 442/203; 442/239; 442/255; 442/32; 442/36; 156/62.8

(57) ABSTRACT

An impact dissipating fabric system includes a first non-woven fabric layer, and a second non-woven fabric layer disposed on one another and coupled together using a lamination film or a resin. In an alternative embodiment, a woven fabric layer may be disposed on either one or both non-woven fabric layers. In yet a further alternative embodiment, and elastomer coating disposed on at least one of the exposed major surfaces of the fabric layer after the fabric layers are coupled to one another.

### CROSS REFERENCE TO RELATED APPLICATIONS

This application is a Continuation-in-Part of U.S. patent application Ser. No. 13/331,004, filed Dec. 20, 2011 and claims benefit of priority to U.S. Provisional Patent Application No. 61/714,279, filed Oct. 16, 2012, the contents of such applications being incorporated by reference herein.

### BACKGROUND OF THE INVENTION

Materials for personal protection against bullets, shrapnel, sharp implements, such as knives, spikes, bayonets, etc. are well known. Such conventional protective devices take the form of multiple layers of material sewn together to create a thick vest-like garment or the lining of helmets, etc. Such thick garments are heavy, thick, rigid, stiff, cumbersome, restrictive and impede movement of the individual wearing the garment and are uncomfortable. This leads to less than optimal compliance with those intended to be protected.

### SUMMARY OF THE INVENTION

To overcome the problems inherent in thick, heavy and uncomfortable personal protective clothing, the inventor have devised a product and method that affords equal, if not better, levels of protections using far fewer layers of material and is thus thinner, lighter and more flexible than conventional products.

In a first embodiment an impact dissipating fabric system comprises a first fabric layer formed using a first weave pattern, and a second fabric layer formed using a second weave pattern different from the first wave pattern. The first and second fabric layers are disposed on one another and coupled together.

In a second embodiment an impact dissipating fabric system comprises a first fabric layer formed with fibers having a first denier, and a second fabric layer formed with fibers having a second denier different from the first denier. The first and second fabric layers are disposed on one another and coupled together.

In a third embodiment an impact dissipating fabric system comprises a first fabric layer formed using a first weave from fibers having a first denier, and a second fabric layer formed using a second weave from fibers having a second denier. In this embodiment at least one of i) the first weave and the second weave are different types of weaves and ii) the first denier and the second denier are different from one another, and the first and second fabric layers are disposed on one another and coupled together.

In one aspect of the invention the first and second fabric layers are formed from a high tensile strength fiber.

In another aspect of the invention the high tensile strength fiber is an aramid fiber.

In a further aspect of the invention a further fabric layer is formed using either the first weave pattern, the second weave pattern or a third weave pattern different from both the first and second weave patterns. The further fabric layer is disposed on and coupled to either the first or second fabric layer based on the type of weave pattern used for the third fabric layer.

In yet a further aspect of the invention i) when the third weave pattern is the same as the first weave pattern, the third fabric layer is disposed on an exposed face of the second fabric layer, and ii) when the third weave pattern is the same as the second weave pattern, the third fabric layer is disposed on an exposed face of the first fabric layer.

In one aspect of the invention the weave patterns are selected from the group consisting of i) a plain weave, ii) a basket weave, iii) a leno weave, iv) a crowfoot weave, v) a twill weave and vi) an eight harness satin weave.

In another aspect of the invention the fabric system may be used in protection equipment selected from the group consisting of vests, helmets, footwear, body armor, vehicle lining, abrasion resistant gear, impact resistant gear, trauma gear, sports gear, blast protection, ballistic protection, stab protection, fragment protection, electronic casings and protective facings, and protection of other goods.

In still another aspect of the invention the first and second fabric layers are coupled together by one of stitching with tack yarn, needle punch to comingle fibers from the adjacent fabric layers with one another, a lamination film, or a resin.

In a further aspect of the invention an elastomer coating may be disposed on at least one of the exposed major surfaces of the fabric layer after the fabric layers are coupled to one another.

These and other aspects are described in detail below with reference to the drawings.

### BRIEF DESCRIPTION OF THE DRAWINGS

The invention is best understood from the following detailed description when read in connection with the accompanying drawings. Included in the drawings are the following figures:

FIG. 1 is perspective view of stitching patterns in accordance with an aspect of the present invention;

FIG. 2 is side view illustrating a tack yarn method in accordance with an aspect of the present invention;

FIG. 3 is a perspective view of a needle punch method in accordance with an aspect of the present invention;

FIG. 4 is a perspective view of an exemplary stitching method in accordance with an aspect of the present invention;

FIG. 5 is a perspective view of an exemplary lamination method in accordance with an aspect of the present invention;

FIGS. 6A-6B are cross-sectional views in accordance with a further aspect of the present invention;

FIGS. 7-12 illustrate various types of conventional weave patterns used in the manufacture of cloth;

FIGS. 13A and 13B are cross-sectional views in accordance with yet another aspect of the present invention; and

FIG. 13C is a view of the non-woven patterns used in the embodiment of FIGS. 13A and 13B.

FIGS. 14A and 14B are views of alternative aspects in woven and non-woven fabrics are combined.

### DETAILED DESCRIPTION OF THE INVENTION

The inventor has determined that by using two layers of material, with a first one of the layers having a first type of weave, and the second layer having a second type of weave different from the first type of weave, an impact dissipating fabric results that is at least as effective at impeding a projectile as is a material having more than two layers. The inventor has further determined that an impact dissipating fabric may be formed by using two or more layers of non-woven material. Thus, a light weight, more comfortable garment is feasible that will be more readily accepted and worn by those it is intended to protect.

Before continuing a listing of definitions for terms used herein will be useful.

### DEFINITIONS

Decitex—also called Detex (and will used herein as such)—is a measure of fiber density, and indirectly of yarn size. Decitex is determined by weighing 10,000 meters of a single thread and recording the mass in grams (or by weighing 100 meters and multiplying the mass in grams by 100). The higher the Detex the larger the diameter of the fiber becomes.

Denier—is a measure of fiber density, and indirectly of yarn size. Denier is determined by weighing 9,000 meters of a single thread and recording the mass in grams (or by weighing 90 meters and multiplying the mass in grams by 100). The higher the Denier the larger the diameter of the fiber becomes.

Fabric—As used herein, the term “fabric” refers to any structure comprising one or more woven or non-woven layers of yards or other elongated material. “Fabric” includes, by way of non-limiting example, knitted fabrics, laminates, micro-laminates, natural fibers (such as cotton), aramid fibers, metal fibers, synthetic fibers (including polypropylene and/or polyethylene), and high-tensile strength fibers.

In traditional ballistics and stab protection, multiple layers are encased with hard plastics, epoxies and hardening resins thereby locking the layers into place making them rigid, hard and stiff. One of the limitations of this method is that when a projectile or object strikes it, only a small area actually dissipates the joules of energy, force and trauma. An aspect of the invention teaches that when double and triple layers of fabric are joined together by means that enable mobility and flexibility and then the joined layers are coated with a flexible, malleable elastomeric coating, the entire surface area absorbs, confuses and dissipates the joules, force and trauma instead of just a small area, thereby reducing the number of layers needed to stop the projectile, thus making the protective gear thinner, lighter, and flexible. This invention will also work well with sport protection, helmets and other protective gear.

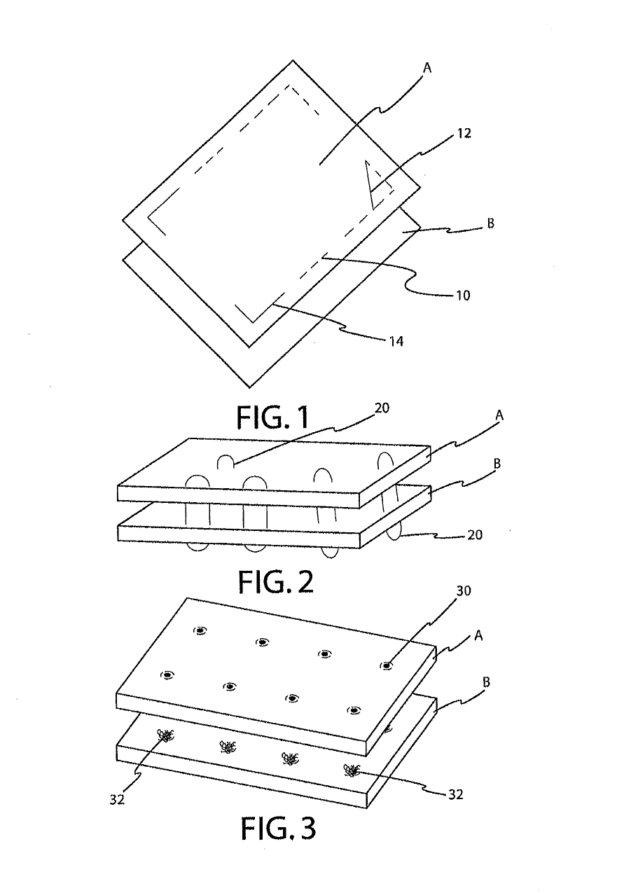

A first exemplary embodiment of the present invention is illustrated in FIG. 1. In FIG. 1, a first weave type fabric A is disposed on a second weave type fabric B.

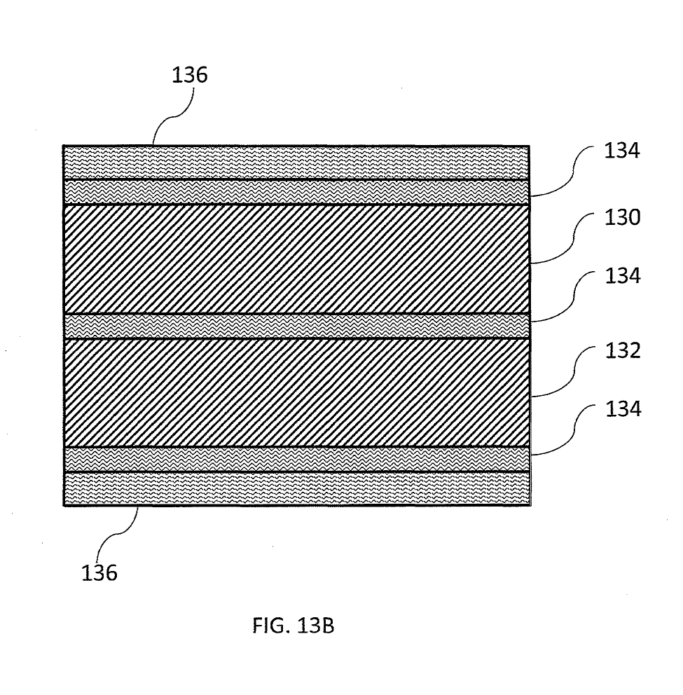

FIGS. 7-12 illustrate conventional material weaves. This weaves are non limiting examples of weaves that may be used to form the various fabric layers of the present invention. For example, FIG. 7 illustrates a plain weave. The plane weave is an interlacing of yarn 70, 72 in an alternating fashion. The plain weave provides good fabric stability. FIG. 8 illustrates the basket weave, which is similar to the plain weave except that two or more filling yarns 80 are alternately interlaced over and under each other. The basket weave is more pliable, flatter, and stronger than the plain weave, but is not as stable. FIG. 9 illustrates the Leno weave. This weave is used where relatively low numbers of yarns are involved. The leno weave locks the yarns in place by crossing two or more warp threads 90 over each other and interlacing with one or more fill threads 92. FIG. 10 illustrates the Crowfoot or four harness satin weave which is more pliable than the plain weave and is easier to conform to curved surfaces. The crowfoot weave uses three by one interlacing, where a fill yarn 104 floats over three warp yarns 100 and under one 102. FIG. 11 illustrates the eight harness satin weave which is similar to the four harness satin weave except that one filling yarn 114 floats over seven warp yarns 110 and under one 112. FIG. 12 illustrates the twill weave. This weave pattern is characterized by a diagonal rib created by one warp yarn 120 floating over at least two filling yarns 122.

Referring again to FIG. 1, in one exemplary embodiment a first type of weave will be used for the fabric A and a second type of weave will be used for the immediately adjacent fabric B. For example, fabric A may be formed using a plain weave, while fabric B may be formed using a basket weave. These different types of weaves may also be combined with the use of different denier or detex in each layer. For example, fabric A may be a basket weave using 600 Detex yarn while fabric B may be formed using a Crowfoot weave using 930 Detex yarn.

The reason for using different types of weaves and/or yarn diameters for immediately adjacent fabric layers is because as a projectile moves through the first layer it may begin to penetrate at a gap where two adjacent yarns meet. However, as the bullet, stab device, knife, spike, shrapnel, fragment or impact force generated by a foreign object including but not limited to: person, ball, bat, stick, weapon (“Projectile”) continues toward the second fabric layer, because of the different yarn diameter, the Projectile will strike the face of the yarn and thus be impeded. The intent is to disrupt and confuse the Projectile upon impact with the material.

Fabric A may be comprised of a weave using fibers having a first detex or denier while fabric B is comprised of weave having a second detex or denier different from the fabric A. For example, fabric A may be formed from a 750 Detex yarn and fabric B may be formed using 930 Detex yarn. In addition, the density of the different layer may also vary. It is contemplated that the density may range from 10×10 yarns/inch to 70×70 yarns/inch for these different materials to provide the desired ballistic resistance. It is also contemplated that the fibers used to form these various layers are a high tensile strength fibers including but not limited to an aramid fiber.

For a double weave fabric, for example, the weaving machine will use tack yarns 10 to join the double fabrics together into one piece of woven fabric. Corner Tack 12 and Bar Tack 14 may also be used as desired. In one exemplary embodiment, the stitching will be between 2 to 10 tack yarns per square inch. Popular conventional stitching designs include, but are not limited to, T-Bar, Corner Tack, Border Stitch, 1-2 Quilt Stitch and 1-2 Box Stitch.

The invention is not limited to two layers. It is contemplated that a third layer of material may be included. In such an embodiment, the third layer may be comprised of a fabric formed from a weave and/or denier that is different from weave and/or denier of the layer upon which it is disposed. In other words, if adding a fabric layer C on top of fabric layer A, fabric layer C may have the same denier as fabric layer B. It is also contemplated that fabric layer C could have a weave pattern and/or denier different that those of fabric layers A and B.

For example, due to the present invention when a bullet hits the different patterns it slows down and starts to tumble. Once the bullet is not spinning left to right but end over end, the effectiveness of the bullet is reduced if not entirely eliminated. When it hits this double pattern the bullet starts to go end over end, mushrooms out, gets confused and starts to lose its momentum. Further, as a Projectile continues toward the double pattern it will encounter greater resistance per square inch and thus be impeded. The intent is to disrupt and confuse the Projectile upon impact with the material.

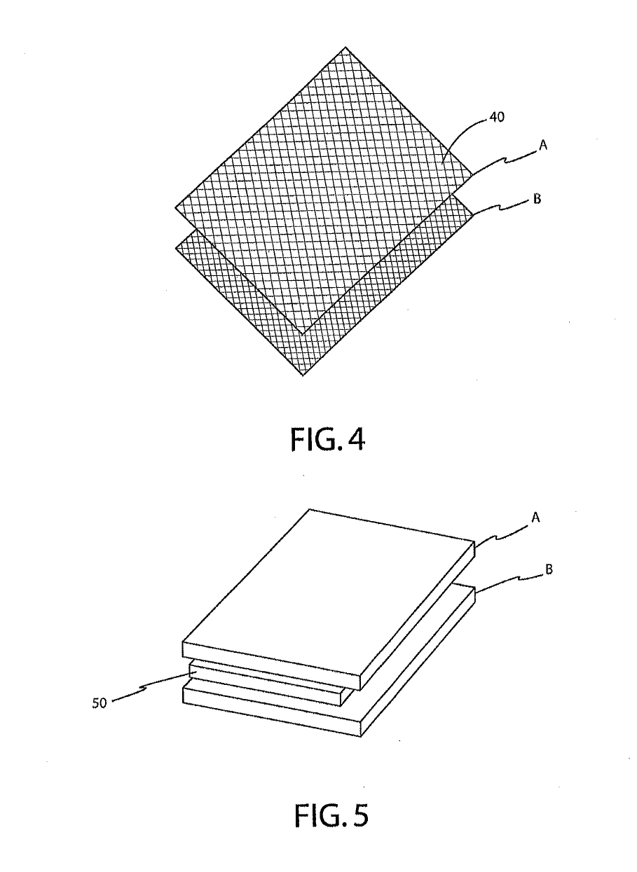

FIG. 2 illustrates an attachment method in accordance with an exemplary embodiment of the present invention. In FIG. 2, Fabric A is attached to fabric B using a tack yarn method. In this approach fabric A is interlocked with fabric B using tack yarns 20 of between 2 to 10 tack yarns per inch. This method is not limited to two layers and it is contemplated that three or more layers may also be attached to one another using this method.

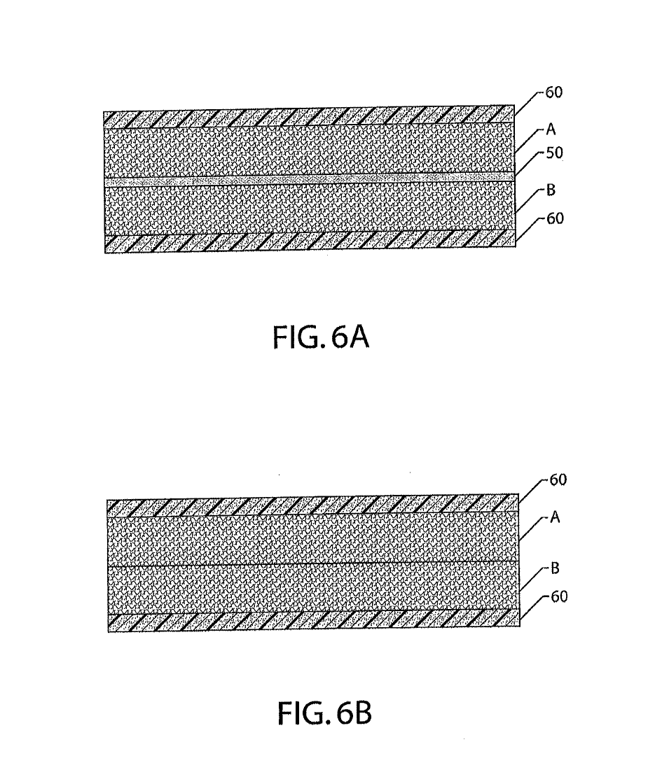

FIG. 3 illustrates an attachment method in accordance with another exemplary embodiment of the present invention. In FIG. 3, Fabric A is attached to fabric B using a needle punch method. In this approach multiple needles (not shown) penetrate through fabric A and fabric B forming needle punctures 30. As the needles pass through the various layers, the needles comingle the yarns of the various fabric layers (for simplicity illustrated as tangles fibers 32 in FIG. 3). As a result, the yarns from each fabric layer become entangled resulting in one solid piece of fabric. This method is not limited to two layers and it is contemplated that three or more layers may also be attached to one another using this method.

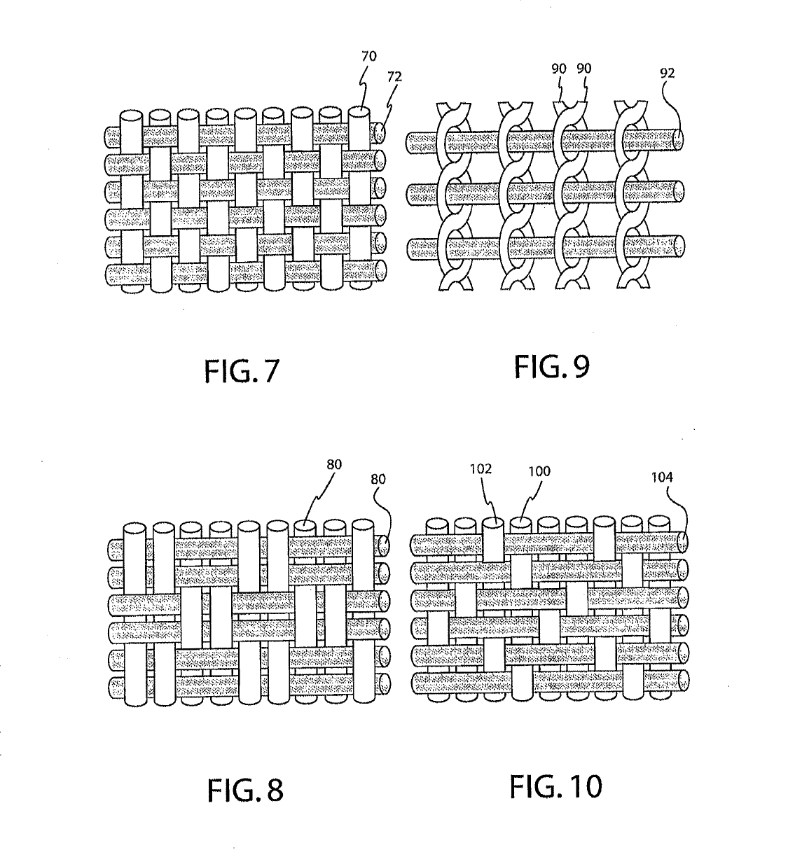

FIG. 4 illustrates an attachment method in accordance with a further exemplary embodiment of the present invention. In FIG. 4, Fabric A is attached to fabric B using various stitch patterns 40. For example, a box stitch, triangle stitch or a quilt stich may be used to couple the different layers of fabric to one another. This method is not limited to two layers and it is contemplated that three or more layers may also be attached to one another using this method.

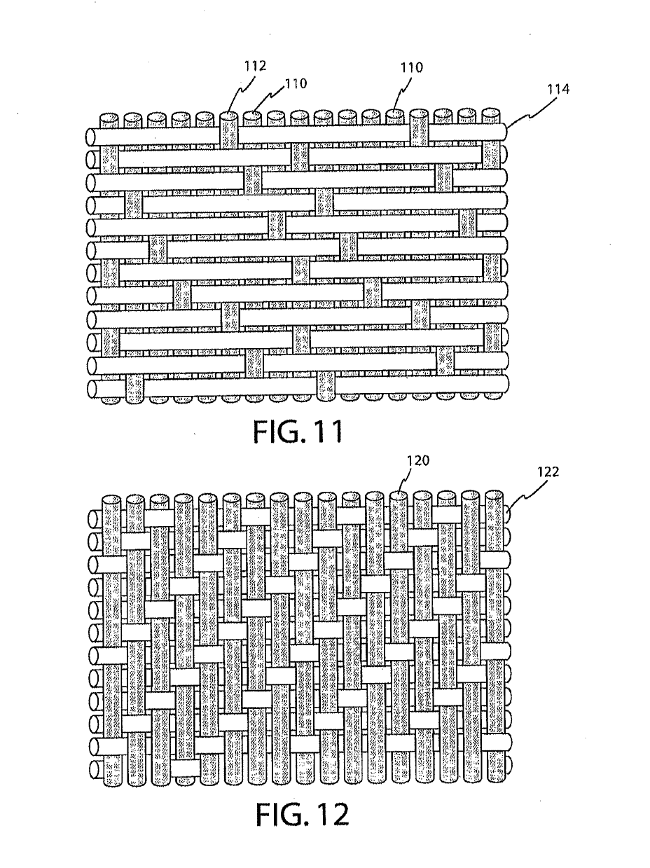

FIG. 5 illustrates an attachment method in accordance with yet another exemplary embodiment of the present invention. In FIG. 5, Fabric A is attached to fabric B using an intermediary layer 50. Intermediary layer 50 may be comprised of a lamination film or a resin for example. After intermediary layer 50 is sandwiched between the two layers of fabric, the combined materials are heated to a predetermined temperature to cure the intermediate later to bond the first and send fabric layers to one another. This method is not limited to two layers and it is contemplated that three or more layers may also be attached to one another using this method. It is also contemplated that the first two layers may be bonded using a lamination film while the resultant combination may be further bonded to a third fabric layer using a resin. It is also contemplated that the three or more layers may be bonded in a single heating process or in different heating processes. For ease of illustration, intermediate layer 50 is shown as not having complete coverage between fabric layer A and B. This is not necessary the case in practice as it is contemplated that intermediate layer 50 would fully cover fabric layers A and B.

As mentioned above, however, the different material layers formed using these various weaves may have different denier or detex than that of the immediately adjacent material layer.

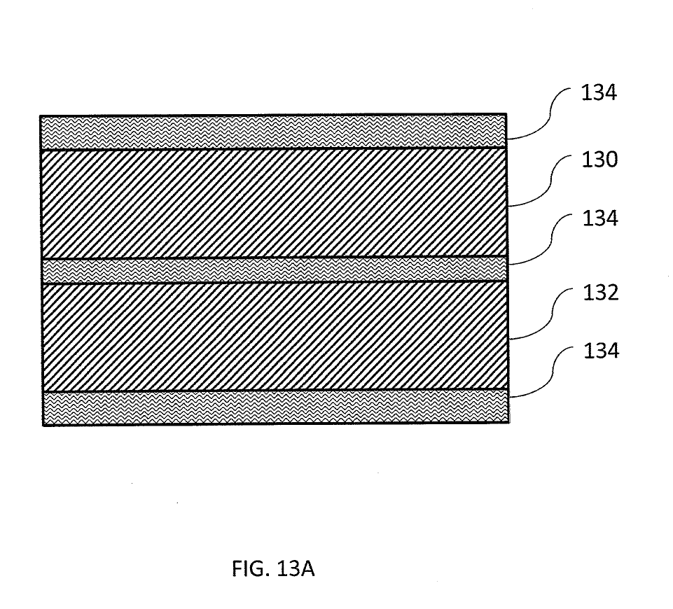

Referring now to FIGS. 6A-6B, another exemplary embodiment of the present invention is shown. In FIGS. 6A-6B, one or more of material layers A and B (and/or the further layers contemplated herein), once bonded or joined to one another, may be subject to coating with an elastomeric layer 60 in accordance with applicant's co-pending application Ser. No. 12/238,944 incorporated herein by reference in its entirely, as well as elastomeric forms of polyethylene, such as chlorosulfonated polyethylene. Such an elastomeric coating will further absorb and dissipate the impact from a bullet, shrapnel, knife or other life threatening projectile. The coating is preferably provided on both major surfaces but the invention is not so limited in that only one major surface may be coated if desired for a particular application. As used herein, a major surface is the planar surface of the fabric layer as opposed to the thin edges (ends) of the fabric.

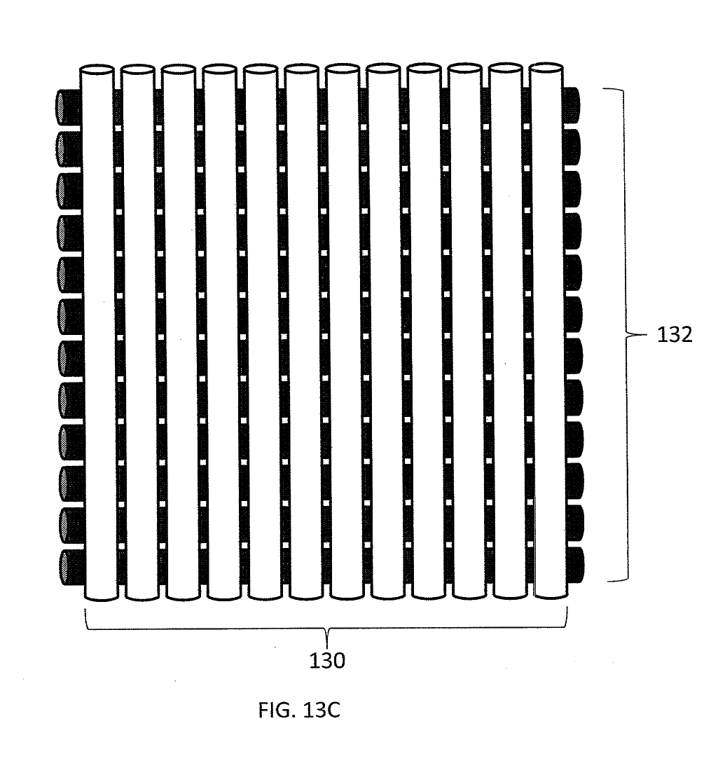

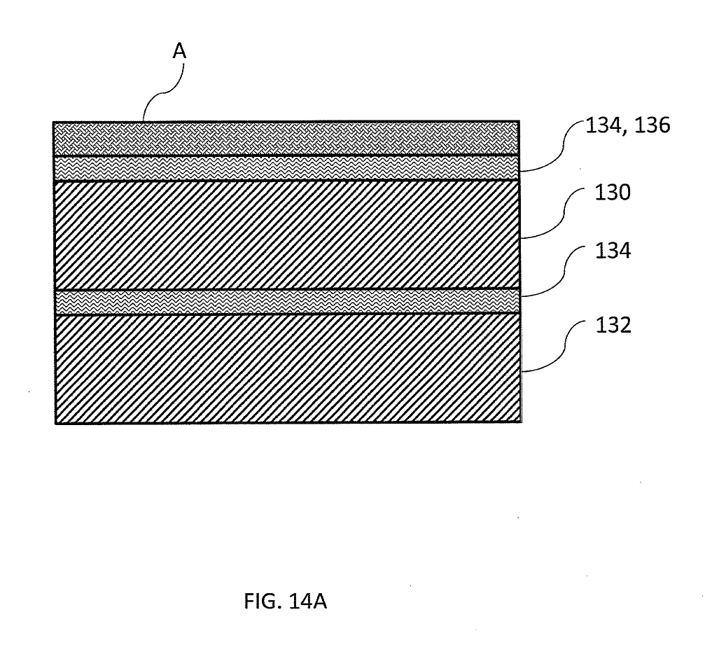

Referring now to FIGS. 13A thru 13C, another exemplary embodiment of the present invention is shown. In FIG. 13A, a plurality of layers of non-woven fabric 130 and 132 are bonded or joined to one another using an intermediary layer 134. In one particular aspect of the invention, as shown in FIG. 13B, intermediary layer 134 may be disposed on either one or both of the remaining exposed surfaces of non-woven fabric layers 130 and 132. Fabric layers 130, 132 and intermediary layer 134 may optionally be coated with an outer elastomeric layer 136. Additional details of this embodiment are described herein.

In an exemplary embodiment fabric layers 130 and 132 comprise unidirectional non-woven fabric, as shown in FIG. 13C. Fabric layers 130 and 132 are arranged at an angle to one another. Preferably, fabric layers 130 and 132 are arranged at a 90° angle with respect to one another, as shown in FIG. 13C. However, fabric layers 130 and 132 may be arranged at any angle such that they are not parallel with respect to one another. Suitable materials for forming fabric layers 130 and 132 include, for example, non-woven high-tensile strength fibers such as aramid fibers or non-aramid (e.g. polyethylene) fibers. Other suitable materials for forming fabric layers 130 and 132 will be known to one of ordinary skill in the art from the description herein. While only two fabric layers 130 and 132 are illustrated in FIGS. 13A thru 13C, it will be understood that the invention is not so limited, and that any number of fabric layers may be used.

Intermediary layer 134 bonds fabric layer 130 to fabric layer 132. Intermediary layer 134 may comprise a lamination film or film resin that may be bonded in the manner described above with respect to intermediary layer 50. Suitable film resins for use as intermediary layer 134 will be known to one of ordinary skill in the art. Where more than two fabric layers are used, multiple intermediary layers 134 may be used such that at least one intermediary layer 134 exists between each adjacent pair of fabric layers. As shown in FIG. 138, intermediary layers 134 may also be positioned on the outer surfaces fabric layers is 130 and 132, in order to preserve the arrangement of the non-woven fabric in layers 130 and 132. An intermediary layer 134 may be positioned on both major surfaces, as shown in the embodiment in FIG. 13B, or one just one major surface of the embodiment.

Once fabric layers 130 and 132 are bonded using intermediary layer(s) 134, they may be coated with an elastomeric layer 136, substantially as described above with respect to elastomeric layer 60. As described above, such an elastomeric coating will further absorb and dissipate the impact from a bullet, shrapnel, knife or other life threatening projectile. The elastomeric coating will also improve durability of the material, including improved atmospheric protection (including temperature, moisture, and UV protection), and improved protection against wear and tear (or other physical degradation). The coating is preferably provided on both major surfaces but the invention is not so limited in that only one major surface may be coated if desired for a particular application. As used herein, a major surface is the planar surface of the fabric layer as opposed to the thin edges (ends) of the fabric.

It is contemplated that the aforementioned fabrics and materials can stand alone or be mixed together such as:
aramid mixed/woven or non-woven fibers alone; or mixed/woven or non-woven with metals and natural fibers such as cotton;
Polyethylene mixed/woven or non-woven alone; or mixed/woven or non-woven with metals and/or natural fibers such as cotton;
Polypropylene woven or non-woven alone; or mixed/woven or non-woven with metals and/or natural fibers such as cotton.

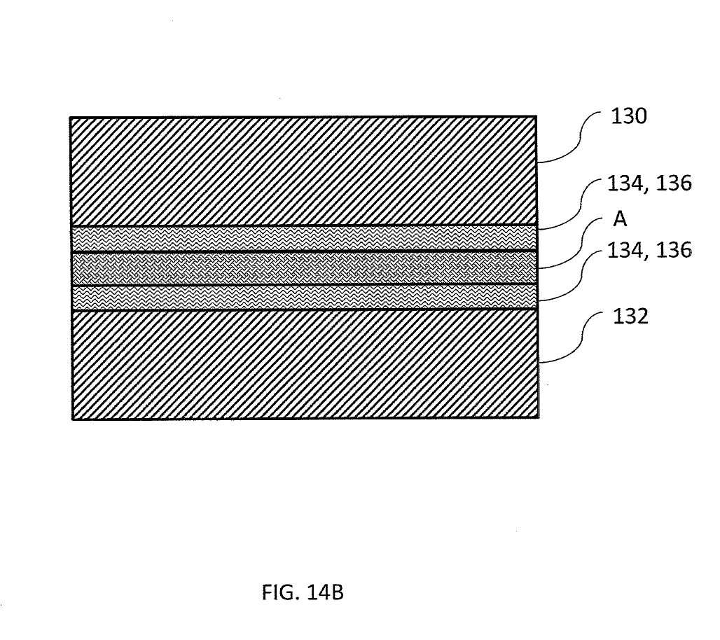

Referring now to FIGS. 14A and 14B, another exemplary embodiment of the present invention is shown. FIG. 14A is similar to FIG. 13A with the addition of woven fabric layer A dispose on non-woven fabric 130. As shown, either intermediary layer 134 or elastomeric layer 136 may be used between woven fabric layer A and non-woven fabric 130. As can be appreciated, FIG. 14A is simplified and that other woven layers may be disposed on non-woven fabric 132. In FIG. 14B, yet another exemplary embodiment of the present invention is shown. In FIG. 14B, woven fabric layer A is disposed between non-woven fabric 130 and is 132. Again, either or both of intermediary layer 134 or elastomeric layer 136 may be used to couple the various layers to one another.

The invention is contemplated for use as a clothing material for use as bullet resistant vests and penetration resistant knee pads, military and riot helmets, other types of body armor, footwear, vehicle lining, casings and other types of protective linings for electronics and other goods, trauma, abrasion resistance for sports gear, motorcycle gear, impact resistance, stab resistance, fragment resistance, ballistic trauma, etc.

In an experimental application, the inventor constructed a bullet resistant vest using the approach above with one of the double layer of fabric that replaced several traditional layers. The result was a vest having equal or better ballistic performance with an apx. 40% weight reduction. Specifically, the experimental vest had a weight of 1 lb/sq. ft. This experimental vest was tested by an independent testing laboratory in accordance with National Institute of Justice (NIJ) testing standards. As those skilled in the art would readily recognize achieving such weight reductions while providing adequate protection is significant and unexpected given the fact that the experimental vest not only met but exceeded the NIJ testing standards.

Another test was conducted for stab protocol. The following Table 1 summarizes NIJ stab test standards

TABLE 1
NIJ-STD-0115.00

| Energy | Required | | Impact Velocity | Impact Velocity |
|---|---|---|---|---|
| Level | Energy | Drop Height | (M/sec) | (ft/sec) |
| L1. E1 | 24 ± 0.5 | 4′ 2.75″ | 5.04 | 16.53 |
| L1, E2 | 36 ± 0.6 | 6′ 5″ | 6.14 | 20.14 |
| L2, E1 | 33 ± 0.6 | 5′ 10″ | 5.87 | 19.26 |
| L2, E2 | 50 ± 0.7 | 8′ 11.5″ | 7.25 | 23.79 |
| L3, E1 | 43 ± 0.6 | 7′ 8″ | 6.71 | 22.01 |
| L3, E2 | 65 ± 0.8 | 11′ 8″ | 8.25 | 27.06 |

In one set of tests, the experimental vest was subjected to stab tests in accordance with NIJ standards. Considering the reduced weight of the subject vest, the results were extraordinary. Specifically, six separate tests were performed on a test panel in accordance with sections 5.7 and 5.8 of the NIJ Standard comprising two spike tests and 4 stab tests using energy levels E1 and E2. Of the six tests, three of the tests were at energy level E1 (one spike and two stab tests). Although under the NIJ standard, penetration of 7 mm for a vest under test is considered acceptable, applicants' vest demonstrated zero penetration. The remaining three tests were performed at energy level E2 (again, one spike and two stab tests). Under the NIJ standard penetration of 20 mm is considered acceptable. Applicants' vest, however, demonstrated zero penetration in two of the tests (the spike test and one stab test) and only 9 mm penetration in the last stab test. Conventional vests cannot provide this type of protection with such low mass. Accordingly, applicants' vest provided results that would be unexpected by those skilled in the art.

While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention.

What is claimed:

1. An impact dissipating fabric system comprising:
a first non-woven fabric layer; and
a second non-woven fabric layer,
wherein the first and second fabric layers are disposed on one another at a predetermined angle relative to one another and coupled together, the predetermined angle being greater than zero degrees.

2. The impact dissipating fabric system according to claim 1, wherein the first and second fabric layers are formed from a high tensile strength fiber.

3. The impact dissipating fabric system according to claim 2, wherein the high tensile strength fiber is an aramid fiber.

4. The impact dissipating fabric system according to claim 2, wherein the high tensile strength fiber is a non-aramid fiber.

5. The impact dissipating fabric system according to claim 4, wherein the high tensile strength fiber is at least one of polyethylene and polypropylene.

6. The impact dissipating fabric system according to claim 1, wherein at least one of the first non-woven fabric layer and the second non-woven fabric layer comprises cotton.

7. The impact dissipating fabric system according to claim 1, further comprising a further fabric layer formed using either a woven fiber having a first weave pattern, or a third non-woven fabric layer, the further fabric layer disposed on and coupled to either the first or second fabric layer.

8. The impact dissipating fabric system according to claim 7, wherein the weave pattern of the further fabric layer using a woven fiber is selected from the group consisting of i) a plain weave, ii) a basket weave, iii) a leno weave, iv) a crowfoot weave, v) a twill weave and vi) an eight harness satin weave.

9. The impact dissipating fabric system according to claim 1, for use in protection equipment.

10. The impact dissipating fabric system according to claim 9, wherein the protection equipment is selected from the group consisting of vests, helmets, body armor, knee pads, footwear, vehicle lining, casings and other types of protective linings for electronics and other goods, abrasion resistant gear, impact resistant gear and trauma gear.

11. The impact dissipating fabric system according to claim 1, wherein the first and second fabric layers are coupled together by a lamination film, or a resin.

12. The impact dissipating fabric system according to claim 1, further comprising an elastomer coating disposed on at least one of the exposed major surfaces of the fabric layer after the fabric layers are coupled to one another.

13. The impact dissipating fabric system according to claim 12, wherein the elastomer coating is selected from the group consisting of urethane rubbers, silicone rubbers, nitrile rubbers, butyl rubbers, acrylic rubbers, natural rubbers, styrene-butadiene rubbers, and chlorosulfonated polyethylene.

14. An impact dissipating fabric system comprising:
a first fabric non-woven layer formed with fibers having a first denier; and
a second non-woven fabric layer formed with fibers having a second denier different from the first denier,
wherein the first and second fabric layers are disposed on one another and coupled together.

15. A method for preparing an impact dissipating fabric system comprising:
forming a non-woven first fabric layer;
forming a second non-woven fabric layer;
disposing the first and second fabric layers on one another; and
coupling the first and second fabric layers together.

16. The method according to any of claim 15 further comprising coating at least one of the exposed major surfaces of the fabric layer after the fabric layers are coupled to one another with an elastomer.

17. A fabric for a protective vest comprising:
a first non-woven fabric layer; and
a second non-woven fabric layer,
wherein the first and second fabric layers are disposed on one another and coupled together.

18. An impact dissipating fabric system comprising:
a first fabric layer formed using a first weave pattern; and
a second fabric layer formed using a second weave pattern different from the first wave pattern,
wherein the first and second fabric layers are disposed on one another and coupled together.

19. The impact dissipating fabric system according to claim 18, wherein the first and second fabric layers are formed from a high tensile strength fiber.

20. The impact dissipating fabric system according to claim 19, wherein the high tensile strength fiber is an aramid fiber.

21. The impact dissipating fabric system according to claim 19, wherein the high tensile strength fiber is a non-aramid fiber.

22. The impact dissipating fabric system according to claim 19, wherein the high tensile strength fiber is at least one of polyethylene and polypropylene.

23. The impact dissipating fabric system according to claim 18, wherein at least one of the first fabric layer and the second fabric layer comprises cotton.

24. The impact dissipating fabric system according to claim 18, further comprising a non-woven fabric layer disposed between the first fabric layer and the second fabric layer.

25. The impact dissipating fabric system according to claim 18, further comprising a non-woven fabric layer disposed on at least one of the first fabric layer and the second fabric layer.

26. The impact dissipating fabric system according to claim 18, further comprising a further fabric layer formed using either first weave pattern, the second weave pattern or a third weave pattern different from both the first and second weave patterns, the further fabric layer disposed on and coupled to either the first or second fabric layer based on the type of weave pattern used for the third fabric layer.

27. The impact dissipating fabric system according to claim 26, wherein i) when the third weave pattern is the same as the first weave pattern, the third fabric layer is disposed on the second fabric layer, and ii) when the third weave pattern is the same as the second weave pattern, the third fabric layer is disposed on the first fabric layer.

28. The impact dissipating fabric system according to claim 18, wherein the weave patterns are selected from the group consisting of i) a plain weave, ii) a basket weave, iii) a leno weave, iv) a crowfoot weave, v) a twill weave and vi) an eight harness satin weave.

29. The impact dissipating fabric system according to claim 18, for use in protection equipment.

30. The impact dissipating fabric system according to claim 29, wherein the protection equipment is selected from the group consisting of vests, helmets, body armor, is knee pads, footwear, vehicle lining, casings and other types of protective linings for electronics and other goods, abrasion resistant gear, impact resistant gear and trauma gear.

31. The impact dissipating fabric system according to claim 18, wherein the first and second fabric layers are coupled together by one of stitching with tack yarn, needle punch to comingle fibers from the adjacent fabric layers with one another, a lamination film, or a resin.

32. The impact dissipating fabric system according to claim 18, further comprising an elastomer coating disposed on at least one of the exposed major surfaces of the fabric layer after the fabric layers are coupled to one another.

33. The impact dissipating fabric system according to claim 32, wherein the elastomer coating is selected from the group consisting of urethane rubbers, silicone rubbers, nitrile rubbers, butyl rubbers, acrylic rubbers, natural rubbers, styrene-butadiene rubbers, and chlorosulfonated polyethylene.
